(19) United States
(12) Patent Application Publication
(10) Pub. No.: US 2008/0163081 A1
(43) Pub. Date: Jul. 3, 2008

(54) Graphical User Interface Using a Document Object Model

(76) Inventors: Christophe J. Gillette, Sunnyvale, CA (US); Daniel C. Wong, San Jose, CA (US); Amith Yamasani, San Jose, CA (US)

Correspondence Address: INGRASSIA FISHER & LORENZ, P.C. (MOT), 7010 E. Cochise Road, SCOTTSDALE, AZ, 85253, US

(21) Appl. No.: 11/617,927

(22) Filed: Dec. 29, 2006

(51) Int. Cl. G06F 3/048

(52) U.S. Cl. 715/762

(57) ABSTRACT

Methods and apparatus are provided for producing dynamic display characteristics on a container widget. One method comprises creating a container widget (210) including at least one child widget (230, 240) utilizing a document object model (DOM) (220). A first display characteristic and a second display characteristic are associated with the child widget, and a first event is attached to the container widget, wherein the child widget is displayed with the first display characteristic prior to the first event occurring and displayed with the second display characteristic if the first event occurs. The method may also include creating a child container widget having at least one grandchild widget utilizing a second DOM (260), associating a third display characteristic and a fourth display characteristic to the grandchild widget, and attaching a second event to the child container widget, wherein the grandchild widget is displayed in a manner similar to the child widget.

### FIELD OF THE INVENTION

The present invention generally relates to computer software, and more particularly, relates to graphical user interfaces.

### BACKGROUND OF THE INVENTION

In the field of software development, a “widget” is an interface component (i.e., software component) that a user utilizes to interact with a computer device. Widgets are often qualified as “virtual” to distinguish them from their physical counterparts. For example, “virtual” buttons are widgets that can be selected with a pointer and actuated with a “click” of a mouse button, rather than physical buttons that can be actuated using, for example, the user's finger.

Widgets are often packaged together in widget toolkits, and programmers use widgets to build graphical user interfaces (GUIs). One class of widget is the “Dashboard widgets” used in connection with computers manufactured by Apple Computer, Inc. of Cupertino, Calif. Widgets, in this case, are downloadable interactive virtual tools that provide services such as the latest news, the current weather, a dictionary, a map program, sticky notes, or a language translator.

Widgets are typically classified into general categories based upon their characteristics. Examples of widget categories include, but are not limited to, selection widgets, text input widgets, output widgets, and window widgets. Selection widgets include, for example, buttons, radio buttons, check boxes, forms, menus (e.g., command menus, text menus, pie menus, and the like), combo boxes (e.g., a text box with an attached menu), icons, toolbars, recursive (e.g., tree view, grid view, and the like), continuous (e.g., scrollbars and the like), and the like widgets. Examples of text input widgets include text boxes (e.g. an edit field and the like), combo boxes (e.g., a text box with an attached menu), and the like widgets. Output widgets include, for example, tool tips, status bars, progress bars, and the like widgets. Examples of window widgets include modal windows, dialog boxes, utility windows, and the like widgets.

Typically, a group of widgets are included in a hierarchical structure commonly known as a “widget tree.” Widget trees are generally composed of one or more “container” widgets, which in turn typically include one or more “child” widgets. Container widgets usually define a layout that organizes its child widgets on the display of a computing device. Examples of container widgets include, but are not limited to, forms, menus, lists, toolbars, and the like widgets. Child widgets are typically “fine-grain” widgets (i.e., lower-level or base widgets) and may include container widgets. Fine-grain widgets include, for example, labels, text fields, scrollbars, icons, and the like widgets.

Furthermore, widgets (both container and fine-grain) typically include a relatively standardized appearance or display characteristic(s). For example, an input text box is generally rectangular, whereas a radio button is generally circular and, when actuated, is filled by a black dot. Moreover, a menu, for example, generally includes a group of tabs lined-up horizontally or vertically with one another. However, container widgets typically do not render anything on the screen except a representation of the child widgets they contain and a background. One example of such a container widget is a computer desktop that shows the icons of the widgets it contains and some kind of background (e.g., a wallpaper image).

In addition, widgets typically include an event attached to them. For example, an event may be a mouse cursor “click” or “double click” on a button, a menu, or an icon. Moreover, an event may be simply moving the mouse cursor over an icon or “click” and “dragging” a scroll bar. As known, there are numerous possible events that may be attached to a widget.

In addition, widgets normally have operations associated with them, which the widgets perform when the event attached to the widget occurs. For example, when a scroll bar is “clicked” and “dragged” the contents on screen scroll up or down depending on the direction the scroll bar is being dragged. Another example includes the event of “hovering” a mouse cursor over an icon or text box and a “pop-up” box or text in the box appears, respectively.

Widgets may be created either programmatically or declaratively. Declarative-created widgets are generally widgets utilized to describe the hierarchy of the widget tree utilizing known user interface concepts (e.g., <toolbar> and <button . . . />, to name just a few of many known concepts).

Notably, when a typical fine-grain widget needs either its graphics or its operation(s) changed, a programmer is needed to change the code associated with the entire fine-grain widget. Thus, if a designer wants to change the appearance of the fine-grain widget, the designer must typically instruct the programmer to modify the underlying code. One way to avoid the designer's reliance on a programmer in such a case is to include a sub-widget tree known as a document object model (DOM) within the widget tree.

A DOM is a description of how a HyperText Markup Language (HTML) or eXtensible Markup Language (XML) document is represented in a tree structure. A DOM provides an object oriented application program interface that enables HTML or XML documents to be parsed into a well-defined tree structure and to operate on the contents of the document. As is typical of widgets included within a DOM, each individual widget or group of widgets include both an appearance and an operation associated with it/them, but separates the instructions controlling the appearance and the instructions controlling the operation from one another. Therefore, a DOM enables a designer to control/change the appearance of individual widgets or groups of widgets by changing the graphics associated with the widget(s), while enabling a programmer to control/change the functionality of the widget(s) by changing the code associated with the functionality of the widget(s). Thus, an advantage to using a DOM within a widget tree is the ability to change the graphics of individual widgets or groups of widgets independent of their respective operational code.

FIG. 1 is a diagram illustrating a representation of at least a portion of a prior art widget tree 100. In this example, widget tree 100 is a container widget 110 including widgets 120, 130, 140, and 150. Here, widgets 120, 130, 140, and 150 are created utilizing DOMs 125, 135, 145, and 155, respectively. Because widgets 120, 130, 140, and 150 are each created by a DOM, their individual graphics may be manipulated by changing the code in their respective DOMS. However, because the graphics of widgets 120, 130, 140, and 150 are not “tied” to container widget 110, their graphics cannot interact with one another or dynamically change during use since container widgets statically display their child widgets.

With the advancements in user/computing device interaction, there is a need to display child widgets in a dynamic fashion. Accordingly, it is desirable to provide methods and apparatus for achieving dynamic visual effects for container-level widgets. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a diagram illustrating a representation of at least a portion of a prior art widget tree including a plurality of document oriented models (DOMs) at lower levels of the widget tree;

FIG. 2 is a diagram illustrating a representation of a widget tree utilizing a DOM to create a container widget;

FIGS. 3A-3C illustrate one example of how the display characteristics of the container widget of FIG. 2 may change as various events occur;

FIGS. 4A-4C illustrate another example of how the display characteristics of the container widget of FIG. 2 may change as various events occur;

FIGS. 5A-5C illustrate one example which demonstrates the flexibility of the container widget of FIG. 2; and

FIG. 6 shows one example of a computing system utilized to implement the container widget of FIG. 2.

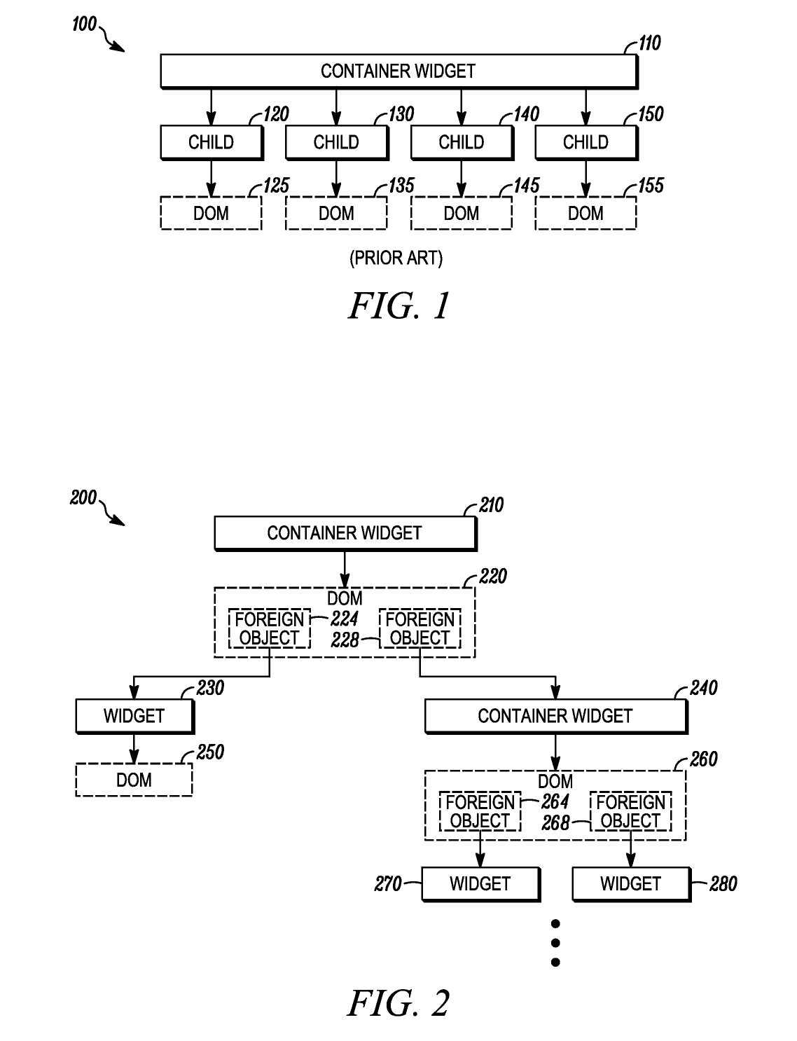

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Embodiments of the present invention include a computer-implemented method to produce display characteristics on a container widget. A container widget having at least one child widget is created utilizing a document object model (DOM). A first event is attached to the container-level widget, and a first display characteristic and a second display characteristic are associated with the child widget. Prior to the first event occurring, the child widget is displayed with the first display characteristic. When and/or after the first event occurs, the child widget is displayed with the second display characteristic.

FIG. 2 is a diagram illustrating a representation of one embodiment of a widget tree 200. At a top-level, widget tree 200 includes a container widget 210 (e.g., a desktop widget, a menu widget, a tab widget, a button widget, a tab group widget, a list widget, a form widget, and the like) created utilizing a DOM 220. As such, the code utilized to give container widget 210 its operations (i.e., functionality) is separate from the code utilized to give its graphical user interface (GUI) display/visual characteristics. Accordingly, the code for the display characteristics of container widget 210 are capable of being changed without changing the underlying code defining the functionality of container widget 210. Likewise, the code defining the functionality of container widget 210 is capable of being changed without changing the code defining the display characteristics of container widget 210.

One or more foreign objects 224 and 228 are included within DOM 220, wherein the foreign objects may be any interface component (e.g., a widget) that is capable of enabling a computing device user to interact with the computing device. In this example, foreign object 224 represents a fine-grain widget 230 and foreign object 228 represents a container widget 240 (i.e., child widgets). Here, because widgets 230 and 240 are included as a portion of DOM 220, widgets 230 and 240 are “linked” to one another in the display code of container widget 210. Accordingly, widgets 230 and 230 are capable of having their respective graphics change, have their respective positions change on container widget 210, and/or have their positions change with respect to one another on container widget 210 as a user performs various events while interacting with a computing device via container widget 210.

In addition, widgets 230 and widget 240 are created by a DOM 250 and a DOM 260 including one or more foreign objects 264 and 268, respectively. Similar to above, the code utilized to give widgets 230 and 240 their respective functionalities is separate from the code defining their respective GUI display/visual characteristics. Moreover, container widget 240 is created by DOM 260 similar to container widget 210 discussed above. Thus, each container widget may include one or more children that are container widgets, which lower-level container widget may include one or more child widgets (i.e., grandchild widgets), which may also include one or more container widgets.

Since container widget 210 is created utilizing a DOM, the graphics code is separate from the code utilized to control the functionality of container widget 210. As such, the children of container widget 210 may include a plurality of display characteristics, wherein one or more characteristics are triggered by the occurrence of an event associated with container widget 210. Accordingly, as one or more events occur in conjunction with container widget 210, the display characteristics of widget 230 and/or widget 240 are capable of changing.

Notably, although illustrated as containing two child widgets, container widget 210 may include any number of child widgets greater than zero. Moreover, the child widgets of container widget 210 may be all fine-grain widgets, all container widgets, or any combination of container widgets and fine-grain widgets.

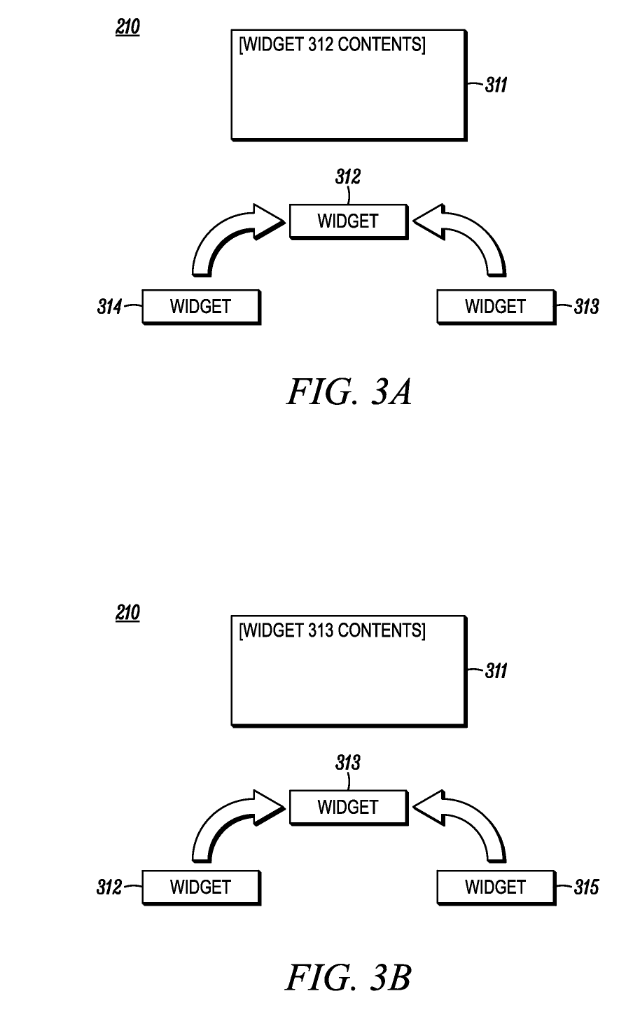

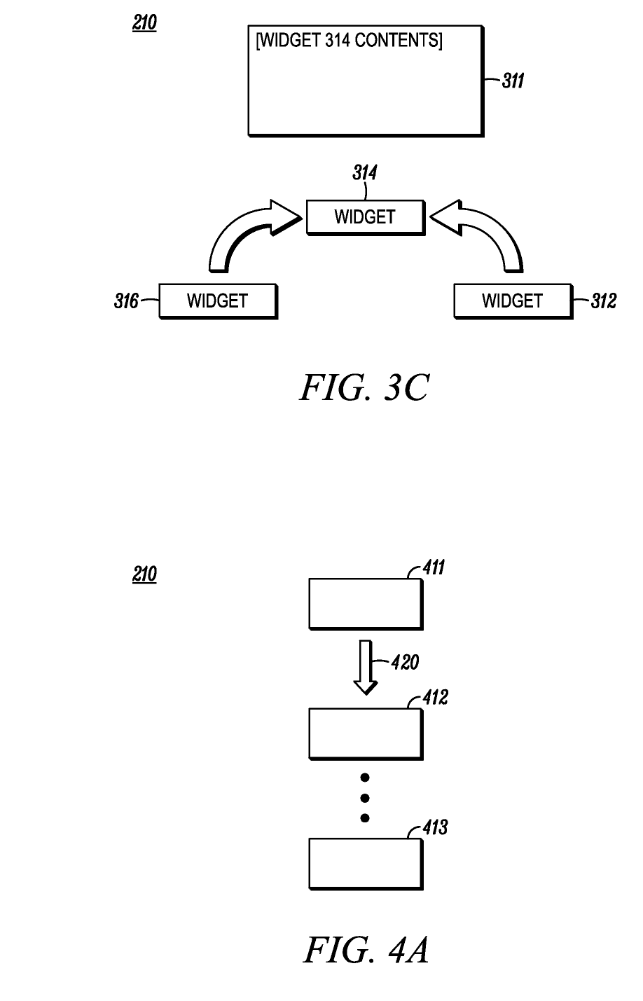

FIGS. 3A-3C illustrates one example of how the display characteristics of container widget 210 may change as various events occur. In this example, container widget 210 is a desktop widget, although other container types are possible. Container widget 210 includes a plurality of child widgets 311-316, each of which may be any widget type known in the art or developed in the future.

As illustrated in FIGS. 3A-3C, widget 311 is a text field to display the contents of widgets 312-316, although widget 311 may be any another type of widget capable of displaying the contents of widgets 312-316. Moreover, widgets 312-316 are each illustrated as button widgets; however, widgets 312-316 may other types of widgets.

Widgets 311-316 include their typical quadrilateral shape; however, they may include any desirable shape. Moreover, widgets 311-316 may each include the same shape, may each include a different shape, or at least two of widgets 311-316 may include different shapes. Furthermore, widgets 311-316 may each include the same size, may each include a different size, or at least two of widgets 311-316 may include different sizes. Further still, although widgets 312-316 are each widgets, widgets 312-316 may each be different widget types, or at least two of widgets 312-316 may be different widget types.

With reference to FIG. 3A, widgets 311-314 are illustrated with widget 312 above and to the left of widget 313, and above and to the right of widget 314, but widgets 316-316 are not displayed. In this example, when a mouse cursor (not shown) hovers over or “clicks” on (i.e., an event) widget 312, the content of widget 312 is displayed in widget 311. When the mouse cursor is moved away from or “clicks” widget 312 a second time (i.e., an event), the content of widget 312 is no longer displayed in widget 311. If the mouse cursor is moved, for example, to the space between widgets 312 and 313 (i.e., an event), widgets 312-316 “rotate” to the left, which result is illustrated in FIG. 3B.

In FIG. 3B, widgets 311-313 and 315 are illustrated, but now with widget 313 above and to the left of widget 315, and above and to the right of widget 312, but widgets 314 and 316 are not displayed. Similar to above, when the mouse cursor hovers over or “clicks” on (i.e., an event) widget 313, the content of widget 313 is displayed in widget 311. When the mouse cursor is moved away from or “clicks” widget 313 a second time (i.e., an event), the content of widget 313 is no longer displayed in widget 311. If the mouse cursor is moved, for example, to the space between widgets 312 and 313 (i.e., an event), widgets 312-316 “rotate” to the right, which result is illustrated in FIG. 3A. If the mouse cursor is then moved, for example, to the space between widgets 312 and 314 (i.e., an event) as illustrated in FIG. 3A, widgets 312-316 “rotate” to the right again, which result is illustrated in FIG. 3C.

In FIG. 3C, widgets 311, 312, 314, and 316 are illustrated, but now with widget 314 above and to the left of widget 312, and above and to the right of widget 316, but widgets 313 and 315 are not displayed. Similar to above, when the mouse cursor hovers over or “clicks” on (i.e., an event) widget 314, the content of widget 314 is displayed in widget 311. When the mouse cursor is moved away from or “clicks” widget 314 a second time (i.e., an event), the content of widget 314 is no longer displayed in widget 311.

Container widget 210 may include any number of widgets similar to widgets 312-316. Accordingly, as the mouse cursor causes an event to occur, the content of the widgets is displayed in widget 311. In addition, as another event occurs (e.g., the mouse cursor moves in between two widgets), the widgets “rotate” in the appropriate direction. Furthermore, although specific events have been described with reference to causing widgets 312-316 to rotate left or right, one skilled in the art will appreciate that any type of event may be utilized to cause such rotation. Moreover, one skilled in the art will recognize that other dynamic display techniques could be utilized instead of rotating widgets 312-316. For example, widgets 312-316 could have different resolutions (e.g., fading, different brightness, color, etc.) indicating the contents of which widget is being displayed in widget 311. Likewise, although specific events have been described with reference to causing the contents of widgets 312-316 to be displayed in widget 311, one skilled in the art will appreciate that any type of event may be utilized to cause such display.

Notably, container widget 210 is capable of having these display characteristics since container widget 210 is created utilizing a DOM. Accordingly, the code to operate the functionality of container widget 210 is separate from the display graphics/characteristics of container widget 210.

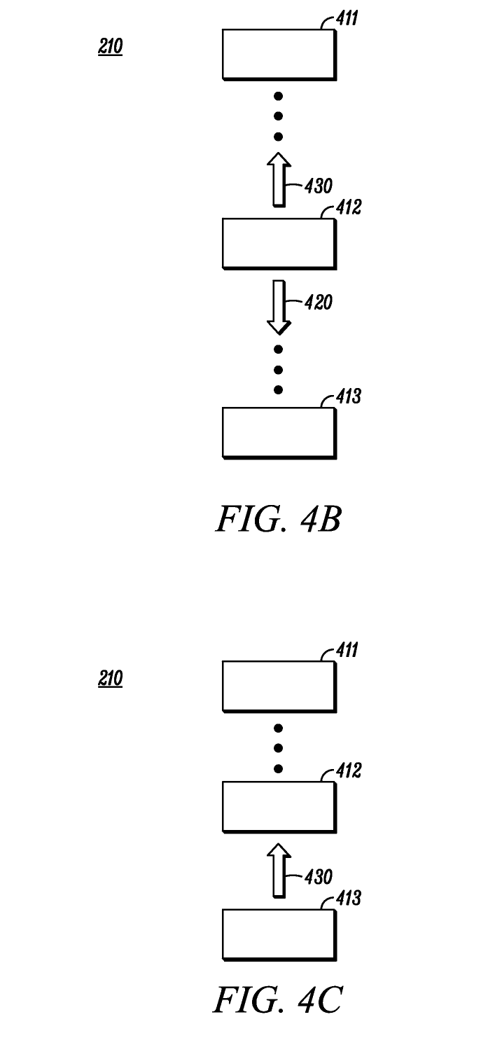

FIGS. 4A-4C illustrates another example of how the display characteristics of container widget 210 may change as various events occur. In the example illustrated in FIGS. 4A-4C, container 210 is a tool bar, although other container types are possible. Container widget includes a plurality of child widgets, each of which may be any widget type known in the art or developed in the future. As illustrated in FIGS. 4A-4C, container widget 210 includes child widgets 411-413.

Container widget 210, in this example, includes events attached to it to indicate to a user where the user is within the tool bar. In other words, container widget 210 includes dynamic graphics to inform the user whether he/she is at the beginning of the tool bar, the end of the tool bar, or somewhere in between.

For example, FIG. 4A illustrates an example of the display characteristics/graphics included on container widget 210 when a user is at the beginning of container widget 210. Here, when the user reaches widget 411, an arrow 420 appears pointing “down” to indicate that the user has reached the beginning of container widget 210, and should the user desire to view/utilize a widget besides widget 411 (e.g., widget 412 and/or 413), the user needs to scroll down to that/those widgets.

FIG. 4B illustrates an example of the display characteristics of included on container widget 210 when the user is intermediate the beginning and the end of container widget 210. Here, when the user is in between the beginning and the end of container widget 210, an arrow 420 pointing “down” and an arrow 430 point “up” appear to indicate that the user may scroll in either direction to view/utilize widget 411 or 413.

FIG. 4C illustrates an example of the display characteristics/graphics included on container widget 210 when a user is at the end of container widget 210. Here, when the user reaches widget 413, an arrow 430 appears pointing “up” to indicate that the user has reached the end of container widget 210, and should the user desire to view/utilize a widget besides widget 413 (e.g., widget 411 and/or 412), the user needs to scroll up to that/those widgets.

Container widget 210 may include any number of widgets similar to widgets 411-413. Accordingly, as the user causes an event (e.g., scrolling or the like) to occur, arrow 420 and/or 430 is displayed depending upon where the user (via, for example, a mouse cursor) is along container widget 210. Although specific events and display characteristics (i.e., arrows) have been described, one skilled in the art will appreciate that any type of display characteristic (e.g., audio, visual, etc.) may be utilized to indicate where the user is along container widget 210. In other words, one skilled in the art will recognize that other dynamic display techniques could be utilized instead of arrows 420 and 430. For example, widgets 411, 412, and/or 413 could have changing resolutions (e.g., fading, different brightness, etc.), color, sizes, shapes, or the like to indicate where the user is located along container widget 210. Likewise, although specific events have been described with reference to causing arrows 420 and 430 to be displayed in container widget 210, one skilled in the art will appreciate that any type of event may be utilized to cause such display.

Notably, container widget 210 is capable of having these display characteristics since container widget 210 is created utilizing a DOM. Accordingly, the code to operate the functionality of container widget 210 is separate from the display graphics/characteristics of container widget 210.

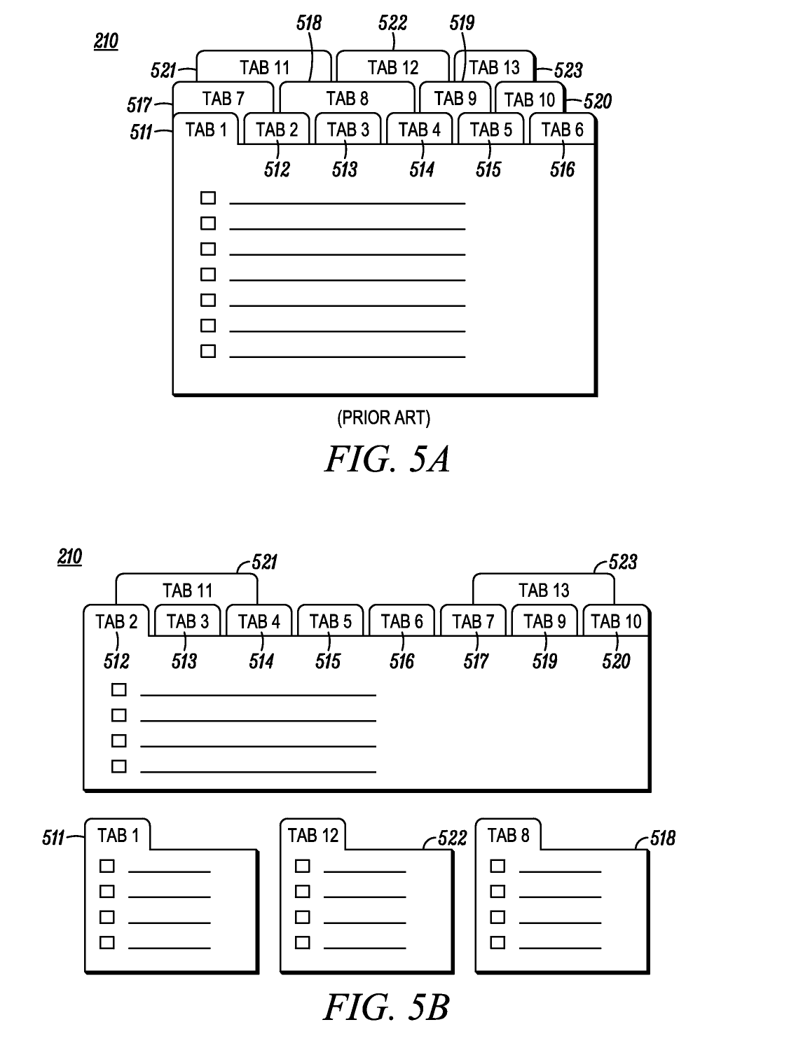

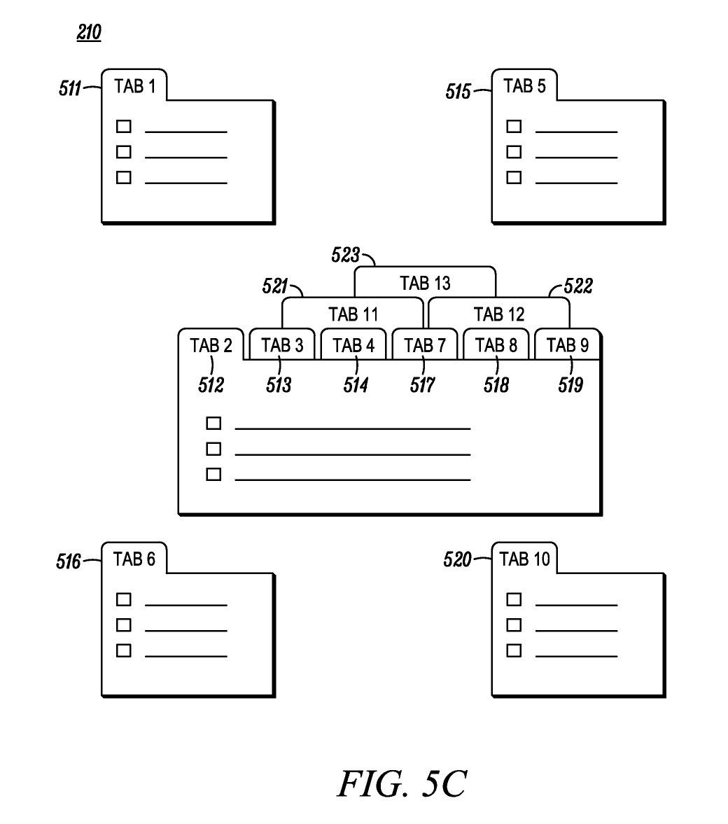

FIGS. 5A-5C illustrates one example which demonstrates the flexibility of container widget 210. In FIGS. 5A-5C, container widget 210 is a folder including widgets 511-523 (i.e., child widgets), which are, in this example, tab widgets, although container widget 210 and widgets 511-523 may be any container widget or child widgets, respectively, known in the art or developed in the future.

FIG. 5A is a diagram illustrating container widget 210 as a folder having a standard configuration as is known in the art. Here, container widget 210 includes widgets 511-523 labeled generically as tabs 1-13. As is known, widgets 511-523 may include, for example, links, information, data, settings, or any other items typically included in tab widgets. As a user “clicks,” for example, a mouse cursor on a particular tab, that tab is moved to the “front” so that its contents are visible to the user. Widgets 511-523 are typically organized in some logical order (e.g., alphabetically, numerically, etc.). If, for example, the user wants to view the contents of multiple tabs (i.e., widgets 511-523), the user is required to “click” back and forth between tabs. Moreover, if a designer, for example, wants to change the appearance of widgets 511-523, a programmer is required to go in and change the code that controls both the display characteristics and functionality of container widget 210.

FIG. 5B is a diagram illustrating one example of how container widget 210, as shown in FIG. 5A, may be modified in accordance with various embodiments of the present invention. In the example illustrated in FIG. 5B, container widget 210 is a folder that still includes widgets 511-523 labeled as tabs 1-13. However, because container widget 510 in FIG. 5B is created utilizing a DOM, the appearance of container widget may be modified without changing the underlying code.

For example, if a designer desires that container widget 210 display the contents of multiple tabs (i.e., widgets 511-523), the designer is able to do such. In the example illustrated in FIG. 5B, the designer can alter the appearance of container widget 210 such that the content of each of tab 1 (i.e., widget 511), tab 12 (i.e., widget 522), tab 8 (i.e., widget 518), and tab 2 (i.e., widget 512) may be displayed such that a user can view all of them without needing to “click” back and forth. To view more than one of tabs 1-13 at the same time, the user may have the ability to, for example, “click” and “drag” the tabs the user desires to view to a pre-determined place in container widget 210. In this example, the pre-determined place is on the bottom of container widget 210, but one tab (i.e., tab 2) is still visible in its traditional format (i.e., in the middle of container widget 210 along with the tabs (i.e., tabs 3-7, 9-11, and 13) whose content is not currently being displayed. This is but one example, and one skilled in the art would recognize that there are many ways to implement viewing multiple tabs utilizing the various embodiments of the present invention.

In making such a modification to container widget 210, the contents of widgets 511-523 (i.e., the functional code) does not require altering since the DOM has separated the code from the display characteristics/graphics. Utilizing a DOM to create container widget 210 also gives a designer the ability to alter the display characteristics of a container should, for example, the current implementation be insufficient for some reason.

For example, if a user decides he/she wishes to view the contents of five tabs of tabs 1-13 at the same time, the embodiment illustrated in FIG. 5B would be insufficient. Accordingly, a designer could “go” into the DOM that created container widget 210 and change the display characteristics of container widget 210.

In the example of FIG. 5C when compared to the example illustrated in FIG. 5B, it is clear that not only are the content of five tabs (e.g., tab 1 (i.e., widget 511), tab 5 (i.e., widget 515), tab 10 (i.e., widget 520), tab 6 (i.e., widget 516), and tab 2 (i.e., widget 512)), but that where the tabs reside while being displayed has also changed from being in the lower-middle of container widget 210, to being in each of the corners of container widget 210 and one tab (i.e., tab 2) residing in the middle of container widget 210 along with the tabs (i.e., tabs 3, 4, 6-9, 11, and 13) whose content is not being currently displayed. Accordingly, container widget 210 may be relatively easily modified to fit changing needs.

As one skilled in the art will appreciate that, although a few examples have been discussed, container widget 210 may include an infinite number of specific configurations to suit many needs because container widget 210 may be any container widget known in the art or developed in the future. As such, the invention is not limited by the specific examples given in FIGS. 3A-3C, 4A-4C, and 5A-5C, but rather, the invention includes the broad concepts discussed above.

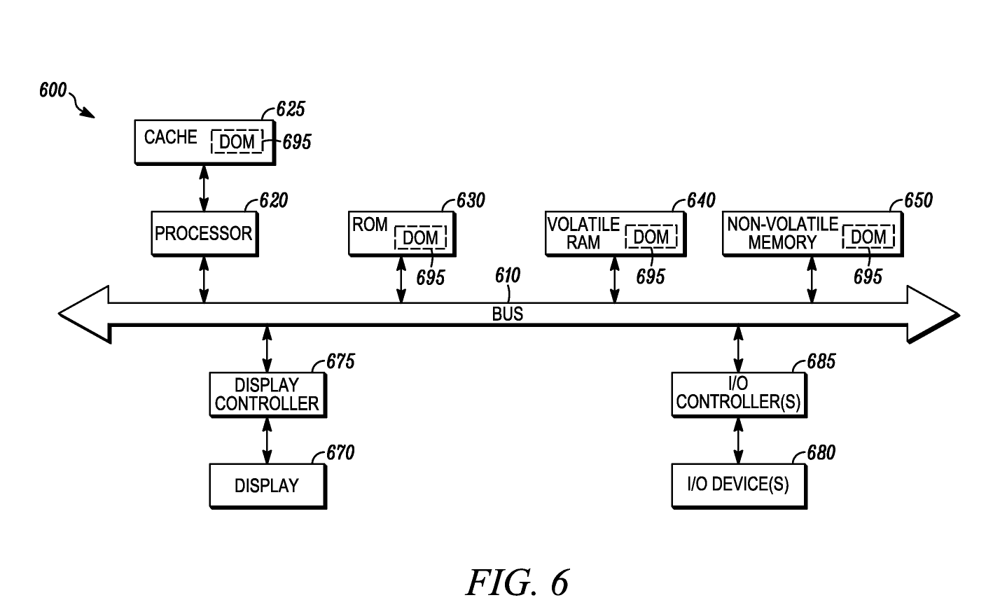

FIG. 6 shows one example of a computing system 600 utilized to implement container widget 210. Note that while FIG. 6 illustrates various components of a computing system, it is not intended to represent any particular architecture or manner of interconnecting the components. It will also be appreciated that network computing devices and other data processing systems which have more, less, or the same number of components are capable of being utilized with embodiments of the present invention.

As shown in FIG. 6, a computing device 600, which is in the form of a data processing system, includes a bus 660 connected to a processor 620 (e.g., a microprocessor from Motorola, Inc. of Schaumburg, Ill.), which is connected to a cache memory 625; a read-only memory (ROM) 630; volatile random-access memory (RAM) 640; and non-volatile memory 650. Bus 660 interconnects these various components to one another, as well as interconnecting these components to a display 670 via a display controller 675, and to one or more peripheral devices, such as an input/output (I/O) device 680 (e.g., a mouse, a keyboard, a modem, a network interface, a printer, a scanner, a video camera and/or another device) via an I/O controller 685. In addition, bus 660 may include one or more additional buses (not shown) connected to each other through various bridges, controllers and/or adapters as is well known in the art.

Volatile RAM 640 is typically implemented as dynamic RAM (DRAM) which requires continual power to refresh or maintain the data in the memory. Non-volatile memory 640, on the other hand, is a memory system which maintains data even after power is removed from the system. Examples of non-volatile memory 640 include, but are not limited to, magnetic hard drives, magnetic optical drives, optical drives, DVD RAM, or similar types of memory. Non-volatile memory 640 is typically RAM, although this is not always the case. While FIG. 6 shows that non-volatile memory 640 is a local device connected directly to the other components in computing device 600, it will be appreciated by one skilled in the art that embodiments of the present invention may utilize a non-volatile memory which is remote from computing device 600 (e.g., a network storage device which is connected to computing device 600 via a network interface such as a modem or Ethernet interface).

In one embodiment I/O controller 685 includes a Universal Serial Bus (USB) adapter for controlling USB peripherals (e.g., flash memory). In another embodiment, I/O controller 685 includes an IEEE-1394 bus adapter for controlling IEEE-1394 peripherals.

Various embodiments of the present invention are embodied, at least in part, in software. That is, the techniques may be carried out in any computing device, computing system, data processing system, and/or any other similar device(s) and/or system(s) which, in response to a processing device (e.g., a processor 620) and/or other similar device(s), executes sequences of instructions included in a DOM 695 within memory (e.g., cache 625, ROM 630, volatile RAM 640, non-volatile memory 650, a remote storage device (not shown), and/or other similar local storage device(s) and/or remote storage device(s)).

Furthermore, various embodiments include hardwired circuitry used, at least in part, in combination with software instructions to implement the present invention. Accordingly, the techniques are not limited to any specific software, hardware, or combination of hardware circuitry and software, nor are the techniques limited to any particular source for the instructions executed by computing device 600.

Notably, to simplify description throughout this description, various functions and/or operations are described as being performed by or caused to be performed by software code. However, those skilled in the art will recognize that the functions result from execution of the code by a processing device (e.g., processor 620).

In addition, embodiments of the present invention are included, at least in part, on a machine readable medium capable of storing software and/or data which, when executed by a computing device, computing system, data processing device, data processing system, and/or the like, causes such device and/or system to perform various methods of the present invention. This executable software and/or data may be stored in various places including, for example, cache 625, ROM 630, volatile RAM 640, non-volatile memory 650, a remote storage device, and/or other similar local storage device(s) and/or remote storage device(s), as illustrated in FIG. 6. Furthermore, this software and/or data, in whole or in part, may be stored in any one of these storage devices or in more than one of these devices, in any combination. Accordingly, a machine readable medium includes any mechanism that provides (i.e., stores and/or transmits) information in a form accessible by a machine (e.g., a computing device, a network device, a personal digital assistant, a manufacturing tool, any device with a set of one or more processing devices, and/or other similar device(s) and/or system(s)). For example, a machine readable medium includes recordable/non-recordable media (e.g., ROM, RAM, magnetic disk storage media, optical storage media, flash memory devices, and/or similar devices), as well as electrical, optical, acoustical, or other forms of propagated signals (e.g., carrier waves, infrared signals, digital signals, and/or the like), and/or the like.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A computer-implemented method for producing display characteristics associated with a container widget in a computing device having a first document object model (DOM) stored in memory, the method comprising:
creating a container widget utilizing the first DOM, the container widget including at least one child widget;
associating, in the first DOM, a first display characteristic and a second display characteristic with the child widget; and
attaching, in the first DOM, a first event to the container widget, wherein the child widget is displayed with the first display characteristic prior to the first event occurring and displayed with the second characteristic if the first event occurs.

2. The computer-implemented method of claim 1, further comprising:
attaching, in the first display code, a second event to the container widget; and
associating, in the first DOM, a third display characteristic with the child widget, wherein the child widget is displayed with the third display characteristic if the second event occurs.

3. The computer-implemented method of claim 1, further comprising:
disassociating, in the first DOM, the second display characteristic from the container widget such that the child widget does not include the second display characteristic if the first event occurs;
associating, in the first DOM, a third display characteristic with the child widget; and
attaching, in the first DOM, the third display characteristic to the first event, wherein the child widget is displayed with the first display characteristic prior to the first event occurring and displayed with the third display characteristic if the first event occurs, wherein disassociating the second display characteristic and associating the third display characteristic occurs without changing the first function code.

4. The computer-implemented method of claim 1, wherein creating the child widget further comprises creating a lower-level container widget.

5. The computer-implemented method of claim 1, wherein the memory includes a second DOM and the child widget includes a second display code, a second function code, and at least one grandchild widget, the method further comprising:
creating the child widget utilizing the second DOM;
attaching, in the second DOM, a second event to the grandchild widget;
associating, in the second DOM, a third display characteristic and a fourth display characteristic with the grandchild widget; and
attaching, in the second DOM, the third display characteristic to the second event, wherein the grandchild widget is displayed with the third display characteristic prior to the second event occurring and displayed with the fourth display characteristic if the second event occurs.

6. The computer-implemented method of claim 5, wherein creating the child widget further comprises creating a first lower-level container widget and wherein creating the grandchild widget comprises creating a second lower-level container widget.

7. The computer-implemented method of claim 5, wherein creating the child widget further comprises creating a lower-level container widget and wherein creating the grandchild widget comprises creating a fine-grain widget.

8. A machine-readable medium containing executable computer program instructions which, when executed by a data processing system, cause said system to perform a method for producing display characteristics of a container widget, the method comprising:
creating a container widget having at least one child widget utilizing a first document object model (DOM), the child widget including a first display characteristic and a second display characteristic and the container widget having an attached first event; and
displaying the child widget with the first display characteristic prior to the first event occurring and displayed the child widget with the second display characteristic if the first event occurs.

9. The machine-readable medium of claim 8, wherein the child widget includes a third display characteristic and the container widget includes a second attached event, the method further comprising display the child widget with the third display characteristic if the second event occurs.

10. The machine-readable medium of claim 8, wherein creating the container widget comprises creating a child container widget.

11. The machine-readable medium of claim 8, the method further comprising:
utilizing a second DOM to create the child container widget, the child widget having at least one grandchild widget, the grandchild widget including a third display characteristic and a fourth display characteristic and the child widget having an attached second event; and
displaying the grandchild widget with the third display characteristic prior to the second event occurring and displayed the grandchild widget with the fourth display characteristic if the second event occurs.

12. The machine-readable medium of claim 11, wherein creating the child widget comprises creating a child container widget.

13. The machine-readable medium of claim 12, wherein creating the child widget comprises creating one of a grandchild container widget and a grandchild fine-grain widget.

14. A data processing system having a first document object model (DOM) for producing display characteristics of a container widget, comprising:
means for creating a container widget having a child widget utilizing the first DOM;
means for attaching a first event to the container widget in the first DOM;
means for associating a first display characteristic and a second display characteristic with the child widget in the first DOM; and
means for displaying the child widget within the container widget, wherein the child widget is displayed with first display characteristic prior to the first event occurring and displayed with the second characteristic if the first event occurs.

15. The data processing system of claim 14, wherein:
the means for attaching the first event comprises means for attaching a second event to the container widget in the first DOM;
the associating means comprises means for associating a third display characteristic with the child widget in the first DOM;
the means for attaching the second display characteristic to the first event comprises means for attaching the third display characteristic to the second event in the first DOM; and
the display means is configured to display the child widget with the third display characteristic if the second event occurs.

16. The data processing system of claim 14, further comprising:
means for disassociating the second display characteristic from the top child widget such that the child widget does not include the second display characteristic if the first event occurs, wherein:
the means for attaching the first event comprises means for attaching a third event to the container widget in the first DOM,
the associating means comprises means for associating a third display characteristic to the child widget in the first DOM, and
the display means is configured to display the child widget with the first display characteristic prior to the first event occurring and display the child widget with the third display characteristic if the second event occurs.

17. The data processing system of claim 14, further comprising a second DOM, the second DOM comprising:
means for creating at least one grandchild widget of the child widget in the second DOM;
means for attaching a second event to the child widget in the second DOM;
means for associating a third display characteristic and a fourth display characteristic to the grandchild widget in the second DOM; and
means for attaching the third display characteristic to the second event in the second DOM, wherein the display means is configured to display the grandchild widget with the third display characteristic prior to the second event occurring and display the grandchild widget with the fourth display characteristic if the second event occurs.

18. The data processing system of claim 17, wherein the grandchild widget is a container widget.

19. The data processing system of claim 14, wherein the child widget is a container widget including at least one grandchild widget.

20. The data processing system of claim 19, wherein the grandchild widget is one of a container widget and a fine-grain widget.
